(19) United States
(12) Patent Application Publication
(10) Pub. No.: US 2005/0268584 A1
(43) Pub. Date: Dec. 8, 2005

(54) Arrangement for separating coarse ash from a flue gas stream

(76) Inventors: Hermann Bruggendick, Schermbeck (DE); Kurt Orehovsky, Radkersburg (AT); Christoph Hagg, Graz (AT)

Correspondence Address: ROBERT W. BECKER & ASSOCIATES, Suite B, 707 Highway 66 East, Tijeras, NM, 87059, US

(21) Appl. No.: 10/943,237

(22) Filed: Sep. 16, 2004

(30) Foreign Application Priority Data
Jun. 8, 2004 (DE) 10 2004 027 845.8

(51) Int. Cl. B01D 46/00

(52) U.S. Cl. 55/483

(57) ABSTRACT

An arrangement for separating coarse ash particles from a flue gas stream is provided, and comprises at least one separation module that is in the form of a block and has a plurality of through channels disposed next to one another in the manner of a screen. The through channels form passages for the passage of flue gas, and each through channel has a cross-sectional area that is less than a cross-section of the coarse ash particles that are to be separated or removed. A side of the separation module that is adapted to receive a flow of the flue gas is made of a ceramic material or of a sintered material having a high mechanical resistance to wear. A holding device is provided for holding the separation module.

### BACKGROUND OF THE INVENTION

The present invention relates to an arrangement for separating coarse ash particles from a flue gas stream, and includes at least one separation module that has a plurality of passages for the passage of flue gas, whereby each passage has a cross-sectional area that is less than a cross-section of the coarse ash particles that are to be separated, and with a holding device for holding the separation module.

During dry firings of coal-fired power plants, ash is produced as dry dust, which is partially carried along by the flue gas stream. Depending upon the type of coal and the temperature distribution within a combustion chamber, areas can occur where the softening point of the ash is exceeded. As a result, the originally dry pulverous ash particles stick together and even sinter together. The coarse ash particles that result (popcorn ash) can, in a known manner, clog the channel walls of catalytic converters of the flue gas cleaning apparatus and/or can lead to significant pressure drops in the catalytic converter, in the downstream air pre-heater and/or in the electrostatic filter.

DE 102 27 639 A1 discloses separating coarse ash out of the flue gas stream, by means of a screen arrangement, before the ash reaches the catalytic converter. The screen arrangement can be deflected out of a position of rest against the effect of a return force. The flue gas stream is constantly subjected to slight pulsations that are sufficient to cause movements or vibrations at the screen arrangement. As a result, the coarse ash particles that are separated off at the screen, to the extent that they adhere to the screen surface, are shaken off.

The present invention proceeds from the recognition that at high flue gas flow velocities, the metal mesh of the known separation screen is subjected to considerable abrasion effects due to the ash particles that strike the screen and pass through the screen. Due to these abrasion effects, openings result in the screen through which the coarse ash can pass, thereby at least in part eliminating the separating function of the screen arrangement. Consequently, the known separation arrangements must be examined, monitored, and possibly replaced in order to maintain their separation effect, at which time the power plant must be shut down either briefly or for a long period of time.

It is therefore an object of the present invention to provide a separation arrangement that is more resistant to wear and requires less maintenance.

### BRIEF DESCRIPTION OF THE DRAWINGS

This object, and other objects and advantages of the present invention, will appear more clearly from the following specification in conjunction with the accompanying schematic drawings, in which:

FIG. 1 is a plan view of one exemplary separation arrangement comprised of a plurality of separation modules that are held next to one another, in the manner of a screen or grating, in a holding device, whereby the embodiment of one separation module is illustrated, and the remaining modules are represented only with outlines;

FIG. 2a is a cross-sectional view taken along the line A-A in FIG. 1;

FIG. 2b is a cross-sectional view taken along the line B-B in FIG. 1;

FIG. 3 is an enlarged detailed view of the separation module shown in the encircled portion of FIG. 1;

FIG. 4 is a cross-sectional view taken along the line IV-IV in FIG. 3; and

FIG. 5 is a perspective view of a separation arrangement comprised of six separation units in conformity with FIG. 1, which are provided for installation in a plane transverse to the gas stream.

### SUMMARY OF THE INVENTION

Proceeding from the arrangement of the aforementioned type, in order to accomplish the object of the present invention pursuant to the invention the separation module is in the form of a block having through channels that are disposed next to one another in the manner of a screen, whereby the through channels form the passages; the separation module has a side that receives the flow of flue gas and is made of a ceramic material or a sintered material having a high mechanical resistance to wear.

The separation module used in the inventive separation arrangement develops a separation effect relative to the coarse ash particles that occur that is comparable to the prior art metal grating. The opening cross-sections and the screen arrangement of the channels that are disposed next to one another can correspond to those of the prior art metal screen. The stability and service life of a block that is provided with through channels and that is made of a wear resistant ceramic or sintered material is many times greater than that of a metal screen, so that the mechanical abrasion and the wear of the novel separation arrangement are drastically reduced.

A particular advantage of the invention lies in the simple and economical manufacture of the separation module, and in particular if the separation module is embodied as an extruded ceramic body. Such a ceramic body is easy to manufacture and to cut to the correct length of the through channels. Alternatively, the ceramic body can also be manufactured as a ceramic molded or pressed body.

Pursuant to a preferred further development of the invention, the through channels have an essentially rectangular cross-section.

In a preferred embodiment of the invention, the holding device is provided with profiled members that engage at the periphery of the separation modules and that, for a simple assembly, are preferably arranged in such a way that they together form an insertion or slide-in guide for the separation module.

In the installed position of the inventive separation arrangement, a plurality of separation modules are intended to span substantially the entire inner cross-section of the exhaust gas or flue gas channel. For this purpose, preferably a plurality of separation modules are interconnected by profiled members transverse to the direction of flow.

In a straightforward and operationally satisfactory embodiment, the profiled members that hold the separation modules are embodied as double U profiled members having receiving grooves that are open toward opposite sides.

In a manner similar to the aforementioned prior art screen arrangement, the novel separating arrangement can be arranged to be deflected by the flue gas stream out of a rest position against the effect of a restoring or returning force. The deflection stroke of the separating arrangement can be delimited by an abutment.

Further specific features of the present invention will be described in detail subsequently.

### Description of Specific Embodiments

Referring now to the drawings in detail, the separation arrangement illustrated in FIG. 1 is provided with a screen or grating comprised of separation modules 1 that are disposed in columns and rows, as well as a holding device 2 that holds the separation modules substantially in an assembly plane.

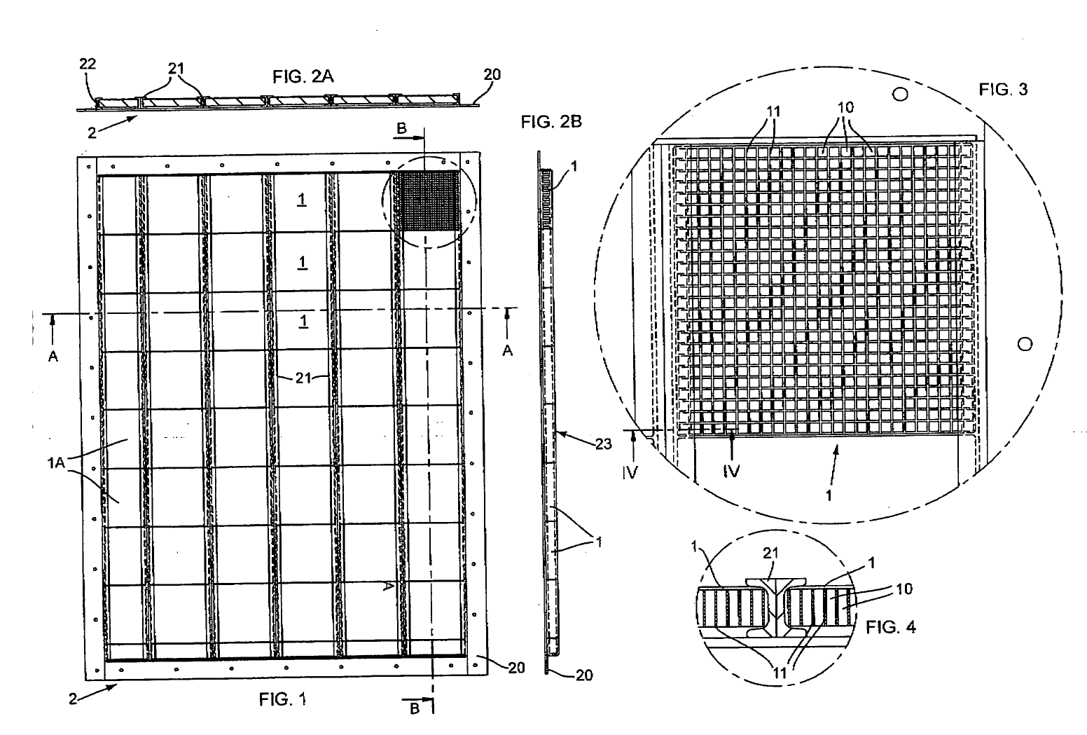

In the illustrated embodiment, the holding device 2 is comprised of a rectangular frame 20 and profiled members 21 and 22 that, pursuant to the illustration in FIGS. 2A and 4, are embodied as double U profiled rails. The double U profiled members are embodied and arranged in such a way that they engage at oppositely disposed, parallel peripheral sides of a separation module 1, and in pairs form a slide-in unit for the module 1. As can be seen in FIG. 1, a plurality of separation modules 1 are held in the frame 20 between two double U profiled rails, and are assembled so as to abut one another.

The configuration of each separation module 1 can be seen from the detailed illustration of FIG. 3 in conjunction with FIG. 4. The separation module 1 is embodied as a block having passages or through channels 10 that are disposed next to one another in a manner of a screen or grating; channel walls 11 separate the through channels 10. In the preferred embodiment, the separation module is comprised of an extruded body of ceramic material having a high mechanical resistance to wear. In the illustrated embodiment, the cross-sectional areas of the through channels 10 are of an essentially square and equal shape. The important thing is that the cross-sectional areas of the through channels be smaller than the cross-sectional areas of the coarse ash particles that are to be separated out, for example being smaller than approximately 5 mm. In practice, it has been shown that the cross-sectional areas should also not be less than about 3 mm. The intervals or pitch between the adjacent channel walls 11 can be between 4-8 mm, preferably between 4 and 5 mm.

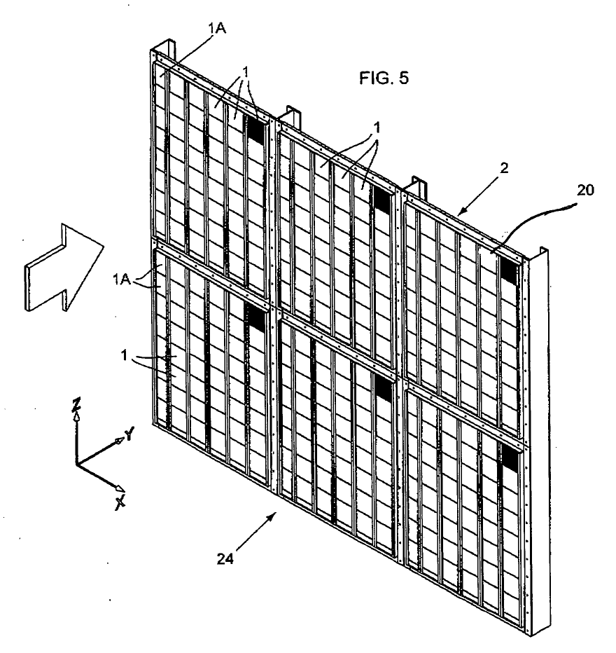

Pursuant to the illustration in FIG. 5, a plurality of frames 20, each with a screen comprised of a plurality of separation modules 1, are disposed in an installation plane transverse to the direction Y of the flue gas stream, in other words, in an X-Z plane. The arrangement of a plurality of frames 20 to form a large—surface separation curtain is in this connection preferably selected such that the cross-section of the flue gas channel, which at the installation location is square or rectangular, is covered as completely as possible by separation modules 1. In this connection, the overall arrangement 24 comprising six frames 20, with the associated separation modules 1, can be disposed in the flue gas channel in such a way as to be deflectable, for example being suspended and pivotable, in order to be able to shake off the separated-off coarse particles into a separation funnel. However, in an alternative embodiment the arrangement 24 can also be essentially fixedly installed, since one can expect that the coarse ash particles will be thrown off from their vertical locations of deposit due to the pulsating flue gas stream and/or due to their own weight. However, in an alternative arrangement, special air or steam rinsing devices, mechanical means or acoustical means (e.g. ultrasonic cleaners), can also be provided for shaking off and removing the coarse ash particles.

A number of modifications are possible within the scope of the inventive concept. For example, instead of the uniform screen of separation modules 1 and/or holding devices 2 described and illustrated in the embodiment, it would also be possible to provide irregular separation modules 1 and/or passage channels 10. In FIGS. 1 and 5, along the respective left columns, abbreviated separation modules 1A are shown that on the left side close off the interior of the surrounding frame 20, and within the frame 20 complete the otherwise uniform module screen to form a closed screen arrangement.

The profiled members 22 that extend along the longitudinal sides of the frame 20 are preferably embodied as single U profiled members, since they only have to hold one column of separation modules (e.g. the modules 1A).

The through channels 10 can also have cross-sectional areas that are other than quadratic. For example, they can be embodied and arranged in a honeycombed manner, or can also have a round cross-section. The important thing is that the side 23 receiving flow (FIG. 2B) is made of a ceramic material or a sintered material having a high mechanical resistance to wear. Such a material is worn only slightly away even by the constant bombardment with dust particles in the manner of a sandblasting blower. In principle, it would be sufficient for the walls 11 that delimit the through channels to comprise ceramic material or sintered material having a high mechanical resistance to wear only in the region of their edges that receive flow. Due to the easy ability to manufacture the modules as extruded ceramic bodies, it is, however, generally expedient to produce the entire separation module 1 as one piece of the same wear-resistant ceramic material.

The specification incorporates by reference the disclosure of German priority document 10 2004 027 845.8 filed Jun. 8, 2004.

The present invention is, of course, in no way restricted to the specific disclosure of the specification and drawings, but also encompasses any modifications within the scope of the appended claims.

1. An arrangement for separating coarse ash particles from a flue gas stream, comprising:
at least one separation module that is in the form of a block and has a plurality of through channels disposed next to one another in the manner of a screen, wherein said through channels form passages for the passage of flue gas, wherein each through channel has a cross-sectional area that is less than a cross-section of said coarse ash particles that are to be separated, and wherein a side of said at least one separation module that is arranged to receive a flow of said flue gas is made of a highly wear resistant material selected from the group consisting of a ceramic material and a sintered material having a high mechanical resistance to wear; and
a holding device for holding at least one separation module.

2. An arrangement according to claim 1, wherein said at least one separation module is an extruded ceramic body.

3. An arrangement according to claim 1, wherein said through channels have an essentially rectangular cross-section and extend parallel to one another.

4. An arrangement according to claim 1, wherein said holding device is provided with profiled members that engage at a periphery of said at least one separation module.

5. An arrangement according to claim 4, wherein two of said profiled members, which engage opposite, parallel peripheral sides of at least one separation module, are disposed in such a way that they together form an insertion guide for said at least one separation module.

6. An arrangement according to claim 4, wherein a plurality of separation modules are held by ones of said profiled members, essentially in a plane of separation.

7. An arrangement according to claim 6, wherein said profiled members that hold said separation modules are embodied as double U profiled members that are provided with receiving grooves that are open toward opposite sides.

8. An arrangement according to claim 1, which is further provided with means for dislodging coarse ash from said at least one separation module.
